(19) United States
(12) Patent Application Publication
(10) Pub. No.: US 2024/0324615 A1
(43) Pub. Date: Oct. 3, 2024

(54) Moonlander

(71) Applicant: Mason Graham, Huntsville, AL (US)

(72) Inventor: Mason Graham, Huntsville, AL (US)

(21) Appl. No.: 18/614,019

(22) Filed: Mar. 22, 2024

Related U.S. Application Data
(60) Provisional application No. 63/435,846, filed on Dec. 29, 2022.

(51) Int. Cl. A23B 4/044; A23L 5/10; A23L 27/10; B65D 23/12

(52) U.S. Cl. CPC A23B 4/044; A23L 5/10; A23L 27/10; B65D 23/12

(57) ABSTRACT

The invention relates to a combustion apparatus and method, including adaptable combustion devices designed to fit over standard containers, combustion chambers larger than the opening of a standard container, and processes for optimizing the combustion of various types of materials. The adaptable combustion devices can universally fit over standard beverage containers. The combustion chambers are designed to be slightly larger than the opening of a standard two-liter bottle. The processes are designed to optimize the combustion of various types of combustible materials.

### TECHNICAL FIELD

The Moonlander pertains to an herb burning device designed to universally fit over standard two-liter beverage containers.

### BACKGROUND

Such devices are often used for a range of purposes, from aromatherapy to culinary applications. However, one common issue that users often face is the lack of versatility and adaptability of these devices. Many herb burning devices are designed to fit specific containers or vessels, limiting their usability. Furthermore, the efficiency of combustion in these devices can often be suboptimal, leading to inefficient use of the herbs and other combustible materials. This can result in a less than satisfactory user experience and can also lead to waste of materials. Therefore, there is a clear need for improvements in this field.

### SUMMARY

In accordance with embodiments, a combustion apparatus is provided, comprising one or more adaptable combustion devices configured to fit over standard two-liter containers, one or more combustion chambers larger than the opening of a standard beverage container, and one or more processes for optimizing the combustion of various types of materials. The adaptable combustion devices can universally fit over standard beverage containers, including Coca-Cola or Pepsi two-liter bottles. The combustion chambers are slightly larger than the opening of a standard two-liter bottle and can accommodate various types of combustible materials. The processes optimize the combustion of various types of combustible materials and offer more efficient methods of burning.

In accordance with other embodiments, a method for combusting materials is provided. The method includes providing a combustion apparatus including one or more adaptable combustion devices configured to fit over standard beverage containers, one or more combustion chambers larger than the opening of a standard beverage container, and one or more processes for optimizing the combustion of various types of materials. The method further includes accommodating various types of combustible materials in the combustion chambers and optimizing the combustion of these materials.

### BRIEF DESCRIPTION OF THE DRAWING FIGURES

The accompanying drawings illustrate several embodiments of the invention and, together with the description, serve to explain the principles of the invention according to the embodiments. It will be appreciated by one skilled in the art that the particular embodiments illustrated in the drawings are merely exemplary and are not to be considered as limiting of the scope of the invention or the claims herein in any way.

FIG. 1 illustrates, a perspective top-view of the apparatus, according to a preferred embodiment of the invention.

FIG. 2 illustrates, a perspective bottom-view of the apparatus, according to a preferred embodiment of the invention.

FIG. 3 illustrates how an herb burning apparatus is applied to a standard beverage container during use.

FIG. 4 illustrates, the processes and interaction of components in the herb burning apparatus in accordance with certain embodiments.

### DETAILED DESCRIPTION

The inventor has conceived, an embodiment for effectively transporting stored material.

The terms “a” or “an”, as used herein, are defined as one, or more than one. The term “plurality”, as used herein, is defined as two, or more than two. The term “another”, as used herein, is defined as at least a second or more. The terms “including” and/or “having”, as used herein, are defined as comprising (i.e., open language). The term “coupled”, as used herein, is defined as connected, although not necessarily directly, and not necessarily mechanically.

Reference throughout this document to “one embodiment”, “certain embodiments”, “an exemplary embodiment” or similar terms means that a particular feature, structure, or characteristic described in connection with the embodiment is included in at least one embodiment of the present invention. Thus, the appearances of such phrases or in various places throughout this specification are not necessarily all referring to the same embodiment. Furthermore, the particular features, structures, or characteristics may be combined in any suitable manner in one or more embodiments without limitation. One or more of the inventions may be widely applicable to numerous embodiments, as may be readily apparent from the disclosure. In general, embodiments are described in sufficient detail to enable those skilled in the art to practice one or more of the inventions, and it should be appreciated that other embodiments may be utilized and that structural changes may be made without departing from the scope of the particular inventions. Accordingly, one skilled in the art will recognize that one or more of the inventions may be practiced with various modifications and alterations. Particular features of one or more of the inventions described herein may be described with reference to one or more particular embodiments or figures that form a part of the present disclosure, and in which are shown, by way of illustration, specific embodiments of one or more of the inventions. It should be appreciated, however, that such features are not limited to usage in the one or more particular embodiments or figures with reference to which they are described. The present disclosure is neither a literal description of all embodiments of one or more of the inventions nor a listing of features of one or more of the inventions that must be present in all embodiments.

Materials described or referenced herein will sometimes be described in singular form for clarity. However, it should be appreciated that particular embodiments may include multiple instantiations of a material unless noted otherwise. Surfaces in some embodiments can be understood as representing segments or portions of those embodiments. Alternate implementations are included within the scope of embodiments of the present invention would be understood by those having ordinary skill in the art.

To the accomplishment of the foregoing and related ends, the following description and annexed drawings set forth certain illustrative aspects and implementations. These are indicative of but a few of the various ways in which one or more aspects may be employed. Other aspects, advantages, and novel features of the disclosure will become apparent from the following detailed description when considered in conjunction with the annexed drawings.

The claimed subject matter is now described with reference to the drawings, wherein like reference numerals are used to refer to like elements throughout. In the following description, for purposes of explanation, numerous specific details are set forth in order to provide a thorough understanding of the claimed subject matter. It may be evident, however, that the claimed subject matter may be practiced without these specific details. Various structures and/or features are not necessarily drawn to scale. In other instances, structures and features are shown in two-dimensional diagram form in order to facilitate describing the claimed subject matter.

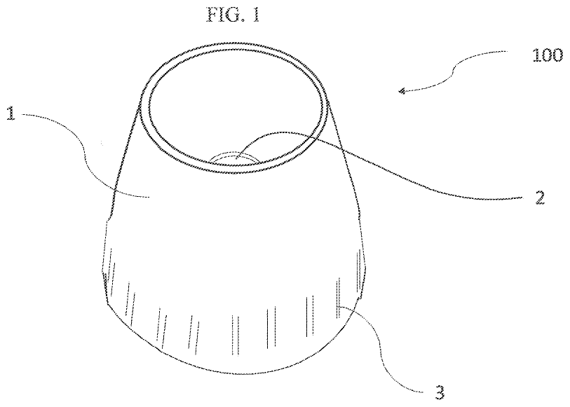

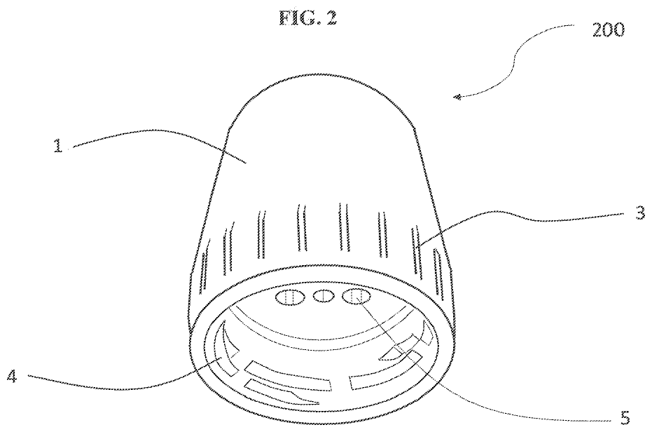

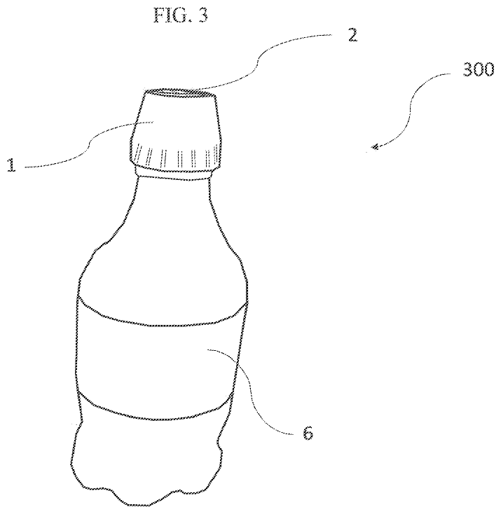

As provided in FIG. 1 (described in conjunction with FIG. 3), a combustion device 1 may be devised that will provide an improved apparatus and method of burning herb by utilizing a novel approach of coupling the apparatus to a standard two-liter beverage container. The combustion device 1 is easily attachable to a standard two-liter beverage container by allowing a user to grip the plurality of ridges 3. Once the device 1 has been attached to the standard beverage container 6, the user can heat the herb by applying an external heat source to the herb stored within the combustion chamber 2. With reference to the attached figures, as illustrated in FIG. 2, in a non-limiting example, the embodiment is a device that allows a user to interchangeably apply the device to standard beverage containers of various sizes utilizing a plurality of ridges 3 to provide a method to allow a user to heat herb. The device 1 is transportable and can be stored in a user's pocket when not in use and easily applied to a beverage container's opening by utilizing grooves 4 that match the threads along the neck of the beverage container. The grooves 4 allow the device to be screwed on and off of a standard beverage container and form a sealed fit along the opening of a beverage container. With reference to the attached figures, as illustrated in FIG. 3, shows the embodiment 1 applied to a standard two-liter beverage container 6. The user will be able to utilize the combustion chamber 2 to burn the herb for personal use.

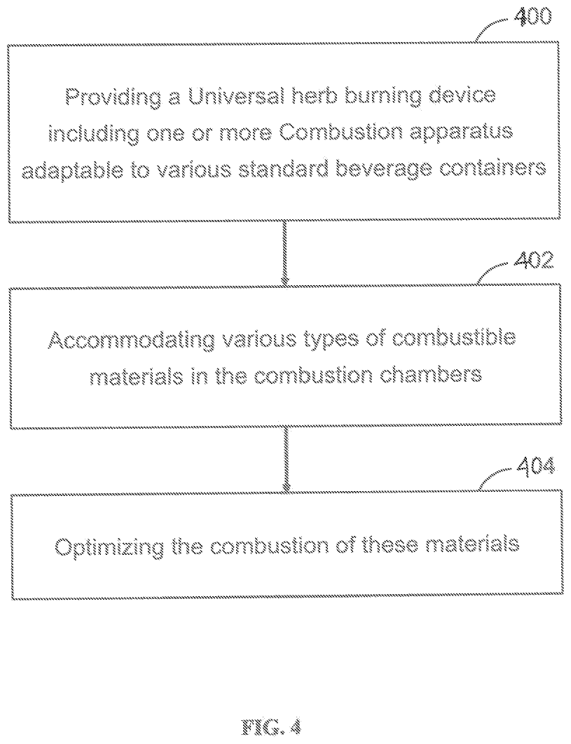

As provided within FIG. 4, step 400, the process begins with the provision of a combustion apparatus. In a non-limiting example, the apparatus includes adaptable combustion device, such as the Universal herb burning device, multi-fit herb burner, or adjustable herb combustion apparatus. The device is designed to fit over various standard beverage containers 6, such as Sprite two-liter bottles, Dr. Pepper two-liter bottles, or Fanta 2-liter bottles as an example. The combustion device has a larger combustion chamber 2, such as Combustion cylinders, Combustion containers, or Combustion compartments. This allows for a more efficient combustion process. The combustion process is optimized for various types of materials, such as Dried lavender, Dried rosemary, Dried thyme, or similar materials.

Step 402, the combustion chamber 2 of the combustion device is used to accommodate various types of materials. These materials can be Dried leaves, Dried flowers, or Dried spices. The materials are placed in the combustion chamber 2, which are slightly larger than the opening of the standard beverage container 6. This allows for a more efficient combustion process.

Step 404, the combustion process is optimized. This involves burning the materials in the combustion chamber 2 in a way that maximizes the combustion efficiency. This can be achieved by adjusting the air flow, temperature, and other factors. The combustion process is optimized for various types of materials, such as Dried wood, Dried paper, or Dried fabric. This is accomplished by using a plurality of orifices 5 for optimal temperature and air flow in the combustion chamber 2 and adjusting the materials of the Combustion apparatus accordingly. The plurality of orifices 5 ensure adequate air flow in real-time, which ensures that the materials are burned at the optimal temperature and with the optimal air flow, resulting in efficient and complete combustion. The end result is a more efficient and effective combustion process.

Although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above-described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure which performs the function in the herein illustrated exemplary implementations of the disclosure.

What is claimed is:

1. A combustion apparatus, comprising:
an adaptable combustion device configured to fit over an opening of standard beverage containers; a housing member, said combustion chamber has a receiving diameter larger than the opening of said standard beverage containers; one or more processes for optimizing the combustion of various types of materials; wherein said housing member includes a plurality of ridges.

2. The combustion apparatus of claim 1, wherein the adaptable combustion device can be universally coupled to the opening of standard beverage containers; wherein said housing member includes at least two orifices and an inner cavity.

3. The combustion apparatus of claim 1, wherein the adaptable combustion chamber is designed utilizing acceptable material that can adjust to be slightly larger than the opening of said standard beverage containers.

4. The combustion apparatus of claim 1, wherein the processes will optimize the combustion of various types of combustible materials.

5. The combustion apparatus of claim 1, wherein said housing member is configured with a first diameter and a second diameter; second diameter is larger than the first diameter.

6. The combustion apparatus of claim 1, wherein said housing member further configured with a plurality of grooves for ensuring a tight fit between the housing and said standard beverage container.

7. The combustion apparatus of claim 1, wherein the processes are more efficient methods of burning.

8. A method for combusting materials, comprising:
providing a combustion apparatus including one or more adaptable combustion devices configured to fit over standard beverage containers, one or more combustion chambers larger than the opening of a standard container, and one or more processes for optimizing the combustion of various types of materials;
accommodating various types of combustible materials in the combustion chambers;
optimizing the combustion of these materials.

9. The method of claim 8, wherein the adaptable combustion devices are universally coupled to a standard beverage container.

10. The method of claim 8, wherein the combustion chambers are slightly larger than the opening of a standard beverage container.

11. The method of claim 8, wherein the processes optimize the combustion of various types of combustible materials; wherein the processes involves burning the materials in the combustion chamber in a way that maximizes the combustion efficiency by adjusting the airflow and temperature, the combustion process is further optimized for various types of materials by using a plurality of orifices for optimal temperature and airflow in the combustion chamber and adjusting the materials of the combustion apparatus, said plurality of orifices ensure adequate air flow in real-time, which ensures the materials are burned at the optimal temperature and with the optimal air flow.

12. The method of claim 8, wherein the adaptable combustion devices are configured to fit over standard two-liter bottles.

13. The method of claim 8, wherein the processes are more efficient methods of burning.
